(19) United States
(12) Patent Application Publication
(10) Pub. No.: US 2019/0172875 A1
(43) Pub. Date: Jun. 6, 2019

(54) ELECTRONIC DEVICE INCLUDING LIGHT BLOCKING MEMBER WITH MICRO-HOLE

(71) Applicant: Samsung Electronics Co., Ltd., Suwon-si (KR)

(72) Inventors: Seung-Goo KANG, Seongnam-si (KR); Gi-Hoon LEE, Hwaseong-si (KR); Dong-Il SON, Hwaseong-si (KR)

(21) Appl. No.: 16/202,880

(22) Filed: Nov. 28, 2018

(30) Foreign Application Priority Data
Dec. 5, 2017 (KR) 10-2017-0166144

(51) Int. Cl. H01L 27/32; G06K 9/00; G06F 21/32; H01L 51/52

(52) U.S. Cl. CPC H01L 27/323; G06K 9/0004; H01L 51/5284; H01L 27/3234; G06F 21/32

(57) ABSTRACT

An electronic device is provided. The electronic device includes a light blocking member with a micro-hole is provided. The electronic device includes a transparent member, a display panel disposed under the transparent member, and including a plurality of pixels, a biometric sensor disposed under the display panel, and configured to acquire at least part of light reflected from an external object contacting at least a partial area of the transparent member in light emitted from at least a part of the plurality of pixels, and a light blocking member disposed between the display panel and the biometric sensor, and including a plurality of micro-holes formed in at least a partial area of the light blocking member. The at least partial area having the micro-holes formed therein faces the biometric sensor, to enable the reflected light to be transmitted therethrough.

### CROSS-REFERENCE TO RELATED APPLICATION(S)

This application is based on and claims priority under 35 U.S.C. § 119 of a Korean patent application number 10-2017-0166144, filed on Dec. 5, 2017, in the Korean Intellectual Property Office, the disclosure of which is incorporated by reference herein in its entirety.

### BACKGROUND

### 1. Field

The disclosure relates to an electronic device including a biometric sensor module, and a light blocking member with micro-holes, which is disposed between a display panel and the biometric sensor module.

### 2. Description of Related Art

An electronic device may refer to a device which executes a specific function according to a loaded program, such as a home appliance, an electronic note, a portable multimedia player (PMP), a mobile communication terminal, a tablet personal computer (PC), a video/audio player, a desktop/laptop computer, or an in-vehicle navigator. For example, such an electronic device may output stored information visually or audibly. Along with an increase in the integration level of electronic devices and the increasing popularity of ultra-high-speed, large-capacity wireless communication, various functions have recently been available in a single electronic device such as a mobile communication terminal. For example, a communication function, an entertainment function such as gaming, a multimedia function such as music/video play, a communication and security function for mobile banking and so on, scheduling, and an electronic wallet function are provided in one electronic device.

In general, a display device is a device which outputs image or video information. Display devices may be installed in most of electronic devices equipped with the information and communication functionality. The development of electric and electronics technology is a driving force behind the dramatic improvement of the performance of display devices. The resulting remarkable improvement of video quality and integration of touch panels in the display devices makes it possible to use the display devices as input devices as well as output devices.

An electronic device having a display device may recognize and identify a user by using information acquired from a user's body part as well as calculate a horizontal component (e.g., position or motion) of an input applied onto a touch panel. Particularly, personal authentication is widely used, which uses unique characteristics of an individual, such as a fingerprint, voice, a face, a hand, or an iris, for user recognition. Recently, the communication functionality including call and text message transmission, and various additional functions using personal information, such as finance and security are provided through an electronic device such as a portable device, and thus the need for a locking device for the electronic device has become significant. To enhance the locking effect, electronic devices equipped with a locking device based on recognition of biometric information about a user are under active development.

An electronic device may calculate the horizontal and vertical positions of a touch input applied in various manners onto a surface of the electronic device. In addition, the electronic device is provided with a fingerprint sensor capable of recognizing a user.

Since the fingerprint sensor has a hardware structure separately from a display device, the fingerprint sensor requires a separate space and causes the electronic device to have a greater depth. In view of the trend toward smaller-size and slimmer mobile devices, the fingerprint sensor faces limitations in position and space. Moreover, to enable recognition of biometric information such as a fingerprint, a user should be close to the fingerprint sensor. As a result, the finger print sensor is exposed outward from the electronic device, degrading the looks of the electronic device.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and method for a display device, and a biometric sensor module (e.g., an optical fingerprint sensor) disposed in an active area of a transparent member.

Additional aspects will be set forth in part in the description which follows and, in part, will be apparent from the description, or may be learned by practice of the presented embodiments.

According to various embodiments of the disclosure, an electronic device may save installation space and cost, and secure sensing performance by using a light emitting device disposed inside a display device as a light emitting device, and an image sensor as a light receiving device in sensing fingerprint information about a user by a biometric sensor module (e.g., an optical fingerprint sensor).

According to various embodiments of the disclosure, since a pin-hole structure (e.g., micro-holes) is disposed inside an electronic device, a biometric sensor module (e.g., an optical fingerprint sensor) in the electronic device may improve outward visibility, and secure sensing performance by reducing a sensing distance from which a user's fingerprint is sensed.

In accordance with an aspect of the disclosure, an electronic device is provided. The electronic device includes a transparent member, a display panel disposed under the transparent member, and including a plurality of pixels, a biometric sensor disposed under the display panel, and configured to acquire at least part of light reflected from an external object contacting at least a partial area of the transparent member in light emitted from at least a part of the plurality of pixels, and a light blocking member disposed between the display panel and the biometric sensor, and including a plurality of micro-holes formed in at least a partial area of the light blocking member. The at least partial area having the micro-holes formed therein faces the biometric sensor, to enable the reflected light to be transmitted therethrough.

In accordance with another aspect of the disclosure, an electronic device is provided. The electronic device includes a housing including a first surface facing in a first direction, a second surface facing in a second direction opposite to the first direction, and a transparent member forming at least part of the first surface, a display device disposed between the first surface and the second surface of the housing, and configured to display information to the outside through the transparent member, a light blocking member disposed to face one surface of the display device, and configured to block light directed in the second direction from the display device, and a biometric sensor module disposed between the first surface and the second surface of the housing, and configured to sense a fingerprint of a user touching the transparent member. The biometric sensor module includes a plurality of light emitting devices configured to emit light toward the transparent member, an image sensor disposed to face one surface of the light blocking member, and configured to sense light reflected from an external object, and a pin-hole structure formed inside or near to the light blocking member, and configured to provide a path for the reflected light directed toward the image sensor.

In accordance with another aspect of the disclosure, a biometric sensor module is provided. The biometric sensor module includes a plurality of light emitting devices configured to emit light toward the outside, an image sensor disposed to face at least part of arrangement of the plurality of light emitting devices, and configured to sense the emitted light after the emitted light is reflected from a user's body, and a pin-hole structure disposed between the plurality of light emitting devices and the image sensor, and configured to guide a path of the reflected light directed toward the image sensor. The pin-hole structure includes a plurality of pin holes arranged apart from each other by a predetermined gap in an area facing the image sensor, and a plurality of walls, each disposed between pin holes, and configured to block interference of the reflected light.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to various embodiments of the disclosure;

FIG. 2 is a perspective view illustrating an electronic device according to an embodiment of the disclosure;

FIG. 3 is a perspective view illustrating an electronic device, seen from a different direction according to an embodiment of the disclosure;

FIG. 4 is a sectional view illustrating an area including a display device and a sensor in an electronic device according to an embodiment of the disclosure;

FIG. 5A is a view illustrating a path of light emitted from light emitting devices of a display device according to an embodiment of the disclosure;

FIG. 5B is a view illustrating a path of a light emitted in FIG. 5A, which is reflected from a user's body and is provided to light-receiving pixels of a sensor according to an embodiment of the disclosure;

FIG. 6 is a view illustrating arrangement of pin holes in a pin-hole structure, and arrangement of light-receiving pixels in an image sensor, corresponding to the pin hole arrangement, according to an embodiment of the disclosure;

FIG. 7 is a view illustrating arrangement of pin holes in a pin-hole structure, and arrangement of light-receiving pixels in an image sensor, corresponding to the pin hole arrangement, according to an embodiment of the disclosure;

FIG. 8 is a view illustrating arrangement of pin holes in a pin-hole structure, and arrangement of light-receiving pixels in an image sensor, corresponding to the pin hole arrangement, according to an embodiment of the disclosure; and

FIG. 9 is a view illustrating a relationship between arrangement of a pin-hole structure and arrangement of an image sensor corresponding to the arrangement of the pin-hole structure according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An electronic device according to various embodiments of the disclosure may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., a program) including one or more instructions that are stored in a storage medium (e.g., internal memory or external memory) that is readable by a machine (e.g., an electronic device). For example, a processor (e.g., a processor) of the machine (e.g., the electronic device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added. Herein below, an electronic device according to various embodiments will be described with reference to attached drawings. In the disclosure, the term “user” may refer to a person using an electronic device or a device using an electronic device (e.g., an artificial intelligent electronic device).

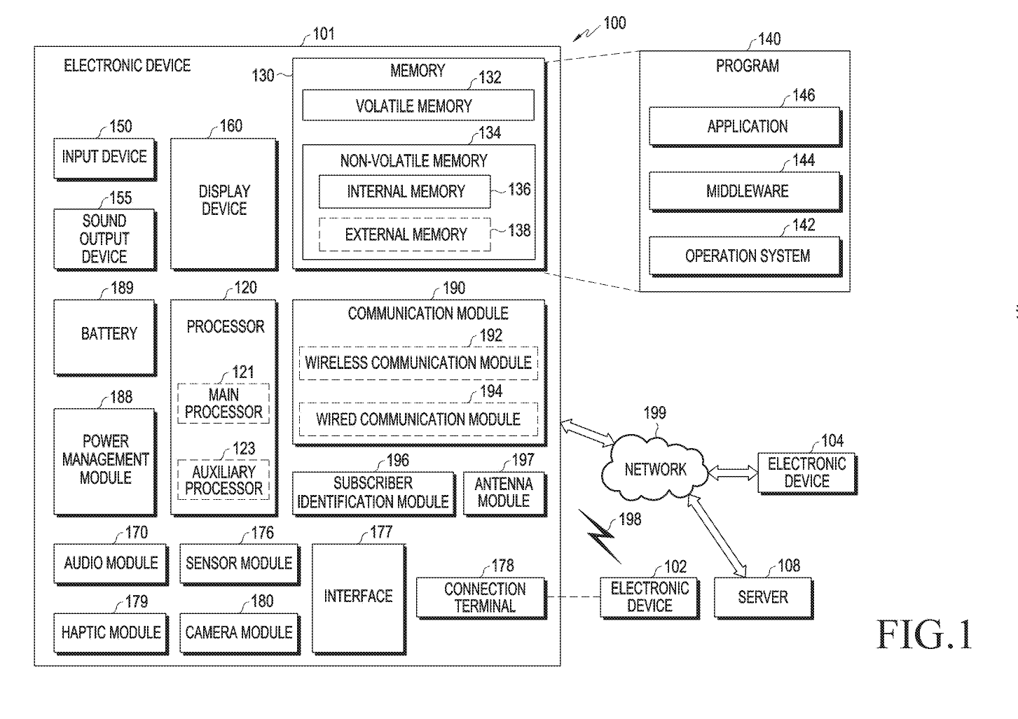

FIG. 1 is a block diagram illustrating an electronic device in a network environment according to various embodiments of the disclosure.

Referring to FIG. 1, an electronic device 101 in a network environment 100 may communicate with an external electronic device 102 via a first network 198 (e.g., a short-range wireless communication network), or an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input device 150, a sound output device 155, a display device 160, an audio module 170, a sensor module 176, an interface 177, a haptic module 179, a camera assembly 180, a power management module 188, a battery 189, a communication module 190, a subscriber identification module (SIM) 196, and an antenna module 197. In some embodiments, at least one (e.g., the display device 160 or the camera assembly 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., the program 140) to control at least one other component (e.g., a hardware or software component) of the electronic device 101 coupled with the processor 120, and may perform various data processing or computation. According to one embodiment of the disclosure, as at least part of the data processing or computation, the processor 120 may load a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

In this case, the auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment of the disclosure, the auxiliary processor 123 (e.g., an ISP or a CP) may be implemented as part of another component (e.g., the camera assembly 180 or the communication module 190) functionally related to the auxiliary processor 123. The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134. The non-volatile memory 13 may include an internal memory 136 or an external memory 138.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, or a keyboard.

The sound output device 155 may output sound signals to the outside of the electronic device 101. The sound output device 155 may include, for example, a speaker or a receiver. The speaker may be used for general purposes, such as playing multimedia or playing record, and the receiver may be used for incoming calls. According to an embodiment of the disclosure, the receiver may be implemented as separate from, or as part of the speaker.

The display device 160 may visually provide information to a user of the electronic device 101. The display device 160 may include, for example, a display, a hologram device, or a projector and control circuitry to control a corresponding one of the display, hologram device, and projector. According to an embodiment of the disclosure, the display device 160 may include touch circuitry adapted to detect a touch, or sensor circuitry adapted to measure the intensity of force incurred by the touch.

The audio module 170 may convert a sound into an electrical signal and vice versa. According to an embodiment of the disclosure, the audio module 170 may obtain the sound via the input device 150, or output the sound via the sound output device 155 or an external electronic device (e.g., the external electronic device 102 (e.g., a speaker or headphone)) wiredly or wirelessly coupled with the electronic device 101.

The sensor module 176 may detect an operational state (e.g., power or temperature) of the electronic device 101 or an environmental state external to the electronic device 101, and then generate an electrical signal or data value corresponding to the detected state. The sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) wiredly or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). The connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. The haptic module 179 may include, for example, a motor, a piezoelectric element, or an electric stimulator.

The camera assembly 180 may capture a still image or moving images. According to an embodiment of the disclosure, the camera assembly 180 may include one or more lenses, image sensors, image signal processors, or flashes.

The power management module 188 may manage power supplied to the electronic device 101. The power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a wired communication channel or a wireless communication channel between the electronic device 101 and the external electronic device (e.g., the external electronic device 102, the external electronic device 104, or the server 108) and performing communication via the established communication channel. The communication module 190 may include one or more CPs that are operable independently from the processor 120 (e.g., the AP) and supports a wired communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single chip, or may be implemented as multi chips separate from each other.

According to an embodiment of the disclosure, the wireless communication module 192 may identify and authenticate the electronic device 101 in a communication network, using subscriber information stored in the SIM 196.

The antenna module 197 may transmit or receive a signal or power to or from the outside of the electronic device 101. According to an embodiment of the disclosure, the communication module 190 (e.g., the wireless communication module 192) may transmit or receive a signal or power to or from the external electronic device via an antenna appropriate for a communication scheme used in the communication network.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 and 104 may be a device of a same type as, or a different type, from the electronic device 101. According to an embodiment, all or some of operations to be executed at the electronic device 101 may be executed at one or more of the external electronic devices 102, 104, and 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

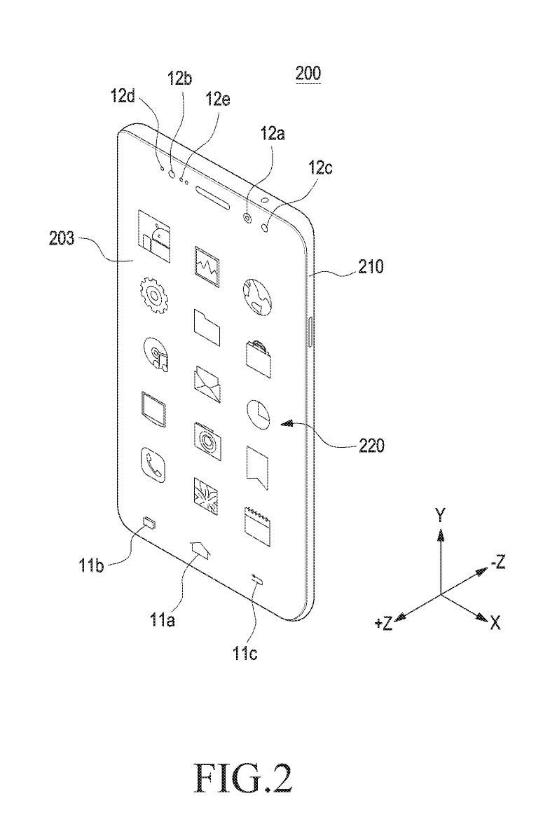

FIG. 2 is a perspective view illustrating an electronic device according to an embodiment of the disclosure.

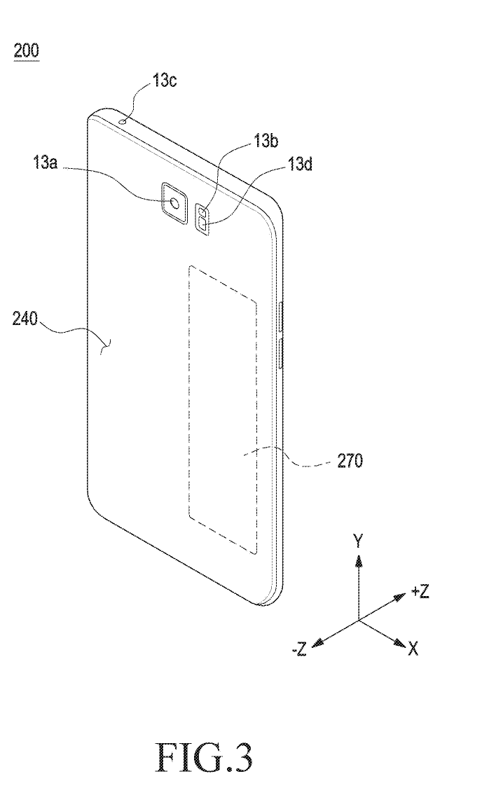

FIG. 3 is a perspective view illustrating the electronic device, seen from a different direction, according to an embodiment of the disclosure.

The electronic device illustrated in FIGS. 2 and 3 may be identical, at least partially or wholly, to the electronic device illustrated in FIG. 1 (e.g., the electronic device 101).

Referring to FIGS. 2 and 3, “X” may represent a width direction of an electronic device 200, “Y” may represent a length direction of the electronic device 200, and “Z” may represent a thickness direction of the electronic device 200, in a 3-axis Cartesian coordinate system. For description of various embodiments of the disclosure, a “first direction +Z” may represent a direction perpendicular to one surface of a transparent member 203, and a “second direction −Z” may represent the opposite direction to the “first direction +Z”.

According to various embodiments of the disclosure, the electronic device 200 may include a housing 210 and a display device 220. The housing 210 may include side surfaces perpendicular to the first direction +Z, and a rear surface 240 facing in the second direction −Z opposite to the first direction +Z. A front surface of the housing 210, facing in the first direction +Z may be opened, thereby allowing the transparent member 203 to close the opened surface of the housing 210. For example, the transparent member 203 may substantially cover an area of the housing 210, facing in the first direction +Z, and the housing 210 may cover the side surfaces and/or the rear surface. In another example, the surface of the housing 210, facing in the first direction +Z may be partially formed in a peripheral area of the transparent member 203.

The electronic device 200 may be provided with, for example, a keypad including mechanical buttons or touch keys 11a, 11b and 11c in an area of the transparent member 203. The touch keys 11a, 11b and 11c may generate an input signal in response to a touch of a user's body. According to various embodiments of the disclosure, the keypad may include only the mechanical buttons or only the touch keys. In another example, the keypad may be configured in a hybrid scheme of the mechanical button scheme and the touch scheme. Further, the keypad may provide various screens displayed on the display device 220, in correspondence with a long or short press or touch time of buttons.

According to various embodiments of the disclosure, the housing 210 is adapted to accommodate various types of electronic parts, and so on, and may be at least partially formed of a conductive material. For example, the housing 210 may include sidewalls forming the outer side surfaces of the electronic device 200, and an exposed part of the electronic device 200 may be fabricated of a conductive metallic material. A printed circuit board (PCB) (not shown) and/or a battery 270 may be accommodated inside the housing 210.

According to various embodiments of the disclosure, terminal circuitry, for example, at least one of an AP, a CP, a memory, or a radio frequency (RF) transceiver may be mounted on the PCB, and the PCB may include a signal line (e.g., an RF signal line). For example, a processor (e.g., the processor 120 in FIG. 1), a communication module (e.g., the communication module 190 in FIG. 1), various interfaces (e.g., the interface 177 in FIG. 1), a power management module (e.g., the power management module 188 in FIG. 1), and so on may be mounted as an IC chip on the PCB. In another example, a control circuit may also be configured as an IC chip and mounted on the PCB. For example, the control circuit may be part of the afore-described processor or communication module. As the battery 270 is accommodated inside the housing 210, a power source may be secured.

According to various embodiments of the disclosure, a first camera 12a, a light source unit 12b, or an iris camera 12c may be included in a top end area of the transparent member 203 in the electronic device 200. For example, the light source unit 12b may be an IR light emitting diode (LED), and the iris camera 12c may capture an eye of the user by using red near IR light emitted from the IR LED as a light source, and recognizes iris information about the user. In another example, a light source unit display lamp 12d, and an illumination sensor or proximity sensor 12e may be included in a top end area of the front surface of the electronic device 200. In another example, a second camera 13a, a heart rate monitor (HRM) 13d, or a flash 13b may be included on the rear surface 240 of the electronic device 200, and a microphone 13c may be included on the top of the electronic device 200.

According to various embodiments of the disclosure, the display device 220 may be exposed through the transparent member 203. The display device 220 may be fabricated, at least partially, of a material capable of transmitting radio waves or a magnetic field therethrough, and disposed between the housing 210 and the transparent member 203, facing in the first direction +Z. The display device 220 may include a display panel mounted on an inner surface of the transparent member 203 formed of tempered glass. A touch panel may be mounted between the transparent member 203 and the display panel. For example, the display device 220 may be used as an input device equipped with a touch screen function as well as an output device which outputs a screen.

According to various embodiments of the disclosure, the electronic device 200 may include a rear cover (e.g., rear surface 240) which protects the rear surface of the housing 210. The rear cover may be mounted to face in the direction opposite to the display device 220 (in the second direction −Z), and fabricated of a material capable of transmitting radio waves or a magnetic field therethrough, such as tempered glass or synthetic resin. The rear cover may serve as the exterior of the electronic device 200, along with the housing 210 and the display device 220.

While not shown in detail in the drawings, according to various embodiments of the disclosure, various structures may be formed on the inner surface of the housing 210 according to a layout of electronic parts inside the electronic device 200, and coupling structures between the housing 210 and the internal electronic parts. For example, a space for accommodating IC chips mounted on the PCB may be formed in the housing 210. The space for accommodating the IC chips may be formed as a recess, a rib surrounding the IC chips, or the like.

According to various embodiments of the disclosure, the display device 220 and a sensor in the electronic device 200 will be described below in detail.

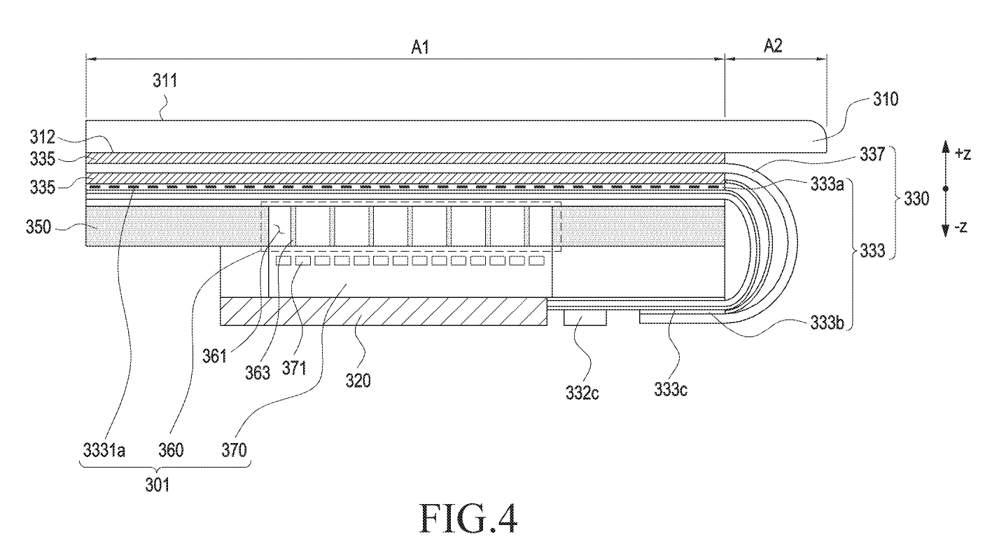

FIG. 4 is a sectional view illustrating an area including a display device and a biometric sensor in an electronic device according to an embodiment of the disclosure.

Referring to FIG. 4, the electronic device (e.g., the electronic device 200 in FIGS. 2 and 3) may include a transparent member 310, a display device 330 which is at least partially exposed through the transparent member 310, a light blocking member 350 which is disposed to face one surface of the display device 330, and includes a pin-hole structure 360, and an image sensor 370 which receives at least part of provided light. The display device 330 may include a display layer 333, a dielectric layer 335, an optical layer (e.g., an optical member and/or a touch sensor panel 337), and a PCB (e.g., flexible PCB 320) electrically coupled with the image sensor 370.

The structure of the display device 330 illustrated in FIG. 4 may be substantially identical, partially or wholly, to the structure of the display device 220 illustrated in FIGS. 2 and 3.

According to various embodiments of the disclosure, the transparent member 310 may include a first surface 311 facing in the first direction +Z, a second surface 312 facing in the second direction −Z opposite to the first direction +Z, and side surfaces facing in a third direction perpendicular to the first direction +Z. The transparent member 310 may include an active area A1 which substantially provides an image and/or a video to the user through the display device 330, and an inactive area A2 extended from the active area A1 to the periphery of the transparent member 310. The display device 330 may be disposed in a flat state under the active area A1 of the transparent member 310, and at least partially in a bent state under the inactive area A2 of the transparent member 310.

According to various embodiments of the disclosure, the front surface of the display device 330 may be exposed through the transparent member 310 (e.g., in the first direction +Z), and the display device 330 may include the display layer 333 and the flexible PCB 320. The flexible PCB 320 may have a control circuit formed thereon, which transmits a control signal to the display layer 333. The display layer 333 (e.g., (active) organic light emitting diode (OLED)) may include a display element layer 333a having a plurality of signal lines and a plurality of pixels, and a support substrate 333c (e.g., formed of polyimide (PI)) disposed to serve as a bottom plate of the display layer 333, and having a wiring layer 333b formed on one surface thereof The wiring layer 333b on which wires are formed may be coupled with the PCB on which the control circuit is formed.

According to various embodiments of the disclosure, the optical member and/or the touch sensor panel 337 may be mounted between the transparent member 310 and the display element layer 333a, or inside the display element layer 333a. For example, the display device 330 may be used as an input device equipped with a touch screen function as well as an output device which outputs a screen. In another example, the dielectric layer 335 may be disposed between the display element layer 333a and a touch sensor panel 337, and the light blocking member 350 including an embossed member and/or a cushioning member may be disposed on the bottom surface of the display element layer 333a.

According to an embodiment of the disclosure, the display element layer 333a may include a substrate (not shown), and an encapsulation member (not shown) which covers and thus protects light emitting devices (e.g., a plurality of pixels) formed on the substrate. The substrate may be a transparent insulation substrate formed of glass or a polymer film If the substrate is formed of a polymer film, the substrate may include a flexible substrate. The encapsulation member may be formed of glass, a polymer film, or a metal. In another example, the encapsulation member may be formed to be a thin-film encapsulation layer in which a plurality of organic films and a plurality of inorganic films are stacked alternately at least once. The encapsulation member may protect a plurality of light emitting devices from external foreign materials (e.g., moisture and/or oxygen) by sealing the plurality of light emitting devices (e.g., the plurality of pixels).

According to various embodiments of the disclosure, at least part of the display element layer 333a may include light emitting devices 3331a which provide light, and the light emitting devices 3331a, the image sensor 370, and the pin-hole structure 360 may collectively form a biometric sensor module 301 (e.g., an optical fingerprint sensor). For example, the light emitting devices 3331a of the display element layer 333a may be used as a light source for the biometric sensor module 301. The light emitting devices 3331a may include a plurality of pixels arranged on the display element layer 333a, and provide light in the first direction +Z. The provided light may be directed to the body of a user U contacting the active area A1 of the transparent member 310 (e.g., to a fingerprint of the user U). The light may be reflected from valleys and/or ridges of the fingerprint of the user, and then reach the image sensor 370 disposed inside the electronic device.

According to various embodiments of the disclosure, the display device 330 disposed between the transparent member 310 and the image sensor 370 may include the dielectric layer 335 and the optical layer 337. The dielectric layer 335 may be disposed in contact with the transparent member 310, and contain, for example, silicon, air, foam, membrane, optical clear adhesive (OCA), sponge, rubber, ink, or polymer (polycarbonate (PC) or polyethylene terephthalate (PET)). The optical layer 337 may be disposed on and/or under the dielectric layer 335. The dielectric layer 335 may attach the transparent member 310 and the optical layer 337, or may have a different refractive index from the transparent member 310 and/or the optical layer 337, to thereby transmit light to the image sensor 370 in a path changed according to the refractive index.

According to various embodiments of the disclosure, the wiring layer 333b formed on the support substrate 332c of the display layer 333 may be extended along the active area A1 and bent in the inactive area A2, and then mounted on the flexible PCB 320. A display IC (D-IC) and/or a touch sensor panel IC (TSP-IC) may be disposed on a surface of the wiring layer 333b, facing in the second direction −Z. The wiring layer 333b may include a flexible printed circuit film, a chip on film with a driving chip, or a tape carrier package.

According to various embodiments of the disclosure, the optical layer 337 allows a screen output from the display layer 333 to pass therethrough, and at least one optical layer 337 may be stacked on the display layer 333. For example, the optical layer 337 may include an optical compensation film to correct a phase difference or the like between screens output from the display panel (e.g., display layer 333). If the display device 330 has the touch screen function, an indium-tin oxide (ITO) film which senses the position of a user's touch may also correspond to the optical layer 337. The optical layer 337 may include an optical compensation film, for example, a polarization film The optical compensation film may be formed by attaching a tri-acetyl cellulose (TAC) film on each of both surfaces of a polyvinyl alcohol (PVA) film which provides a polarization function, and protecting the surface-side TAC film with a surface coating layer.

According to various embodiments of the disclosure, the image sensor 370 may be disposed under the display device 330 (e.g., in the second direction −Z), and sense fingerprint information about a fingerprint of the user by receiving light which has passed through the transparent member 310 and the display device 330. The image sensor 370 may be mounted on the top surface of the flexible PCB 320, and electrically coupled with the flexible PCB 320.

According to an embodiment of the disclosure, if the image sensor 370 is viewed from above the transparent member 310, the entire area of the image sensor 370 may substantially overlap with the display device 330. In another example, the entire area of the image sensor 370 may substantially overlap with a touch sensor and/or a pressure sensor (not shown). For example, the image sensor 370 may be stacked under at least a partial area of the display device 330. The user may touch his or her finger on at least a partial area of the transparent member 310 formed on the display device 330, and biometric information about the user, such as fingerprint information about the user, may be provided to the image sensor 370. The image sensor 370 may include a plurality of light-receiving pixels 371 and a support plate (not shown), and the support plate may be a polymer film or a glass substrate.

According to various embodiments of the disclosure, a lens which condenses light passed through the transparent member 310 and has a short focal length for miniaturization of an optical scanning device may be used as the image sensor 370. In another example, the image sensor 370 may include an array lens in order to cope with the size of a scanned image. Herein, the array lens may be formed in a matrix structure.

According to various embodiments of the disclosure, the light blocking member 350 may be disposed between the image sensor 370 and the display device 330, to suppress light scattering, and the pin-hole structure 360 may be formed in the light blocking member 350. The light blocking member 350 may suppress scattering of light emitted to the outside (e.g., in the rear direction of the electronic device 200 illustrated in FIG. 3) by controlling light to be directed to the transparent member 310. In another example, an area of the light blocking member 350 may be opened to provide light received from the transparent member 310 to the image sensor 370. For example, an area of the light blocking member 350, corresponding to the image sensor 370, may be opened so as to provide a space in which light provided through an area of the transparent member 310 may reach the image sensor 370.

According to an embodiment of the disclosure, the light blocking member 350 may be provided as a layer which shields the rear surface of the display device 330. The light blocking member 350 may be, for example, a cushioning member, an embossed member, or a copper (CU) sheet, and may contain black color.

According to an embodiment of the disclosure, the pin-hole structure 360 formed in the light blocking member 350 or disposed near to the light blocking member 350 may have a plurality of pin holes 361 arranged in an area facing the image sensor 370, and the plurality of pin holes 361 may provide a path in which light reflected from a fingerprint of the user is transmitted to the image sensor 370. The pin holes 361 may be formed as holes of a micro-size (e.g., micro-holes). By forming the pin-hole structure 360 in the light blocking member 350, a distance between the transparent member 310, where a finger is placed for sensing, and the image sensor 370 is reduced.

According to an embodiment of the disclosure, the pin-hole structure 360 may be formed to be an array corresponding to the light-receiving pixels 371 formed in the image sensor 370. For example, the pin holes 361 of the pin-hole structure 360 may be arranged apart from each other by a predetermined gap, in correspondence with one or more light-receiving pixels 371. In another example, as a wall 363 is prepared between every two of the pin holes 361, the reflected light may be guided accurately to a pixel of the image sensor 370, corresponding to a pin hole. For example, the wall 363 may block noise light which could be provided adjacent to pixels. The wall 363 may be formed in the same thickness and of the same material, as the light blocking member 350. For example, the pin-hole structure 360 may be stacked on the light blocking member 350, which may be realized by micro perforation after the light blocking member 350 is laminated.

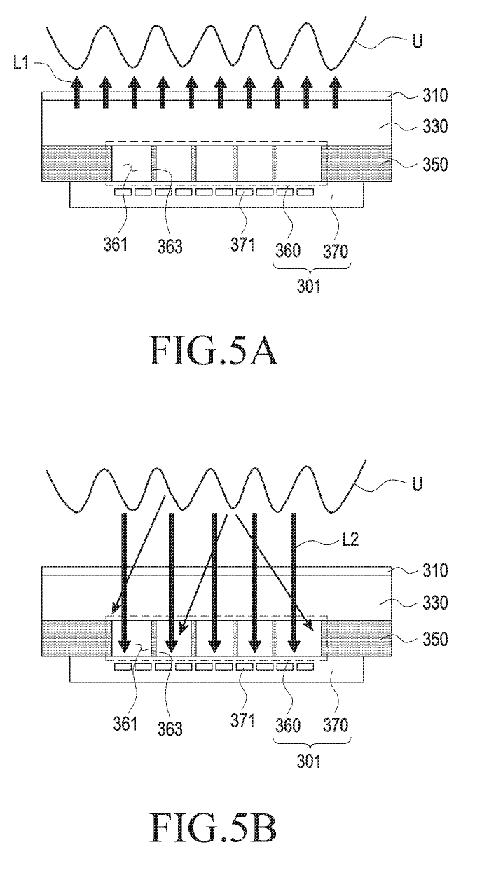

FIG. 5A is a view illustrating a path of light emitted from light emitting devices of a display device according to an embodiment of the disclosure.

FIG. 5B is a view illustrating a path of light emitted in FIG. 5A, which is reflected from a user's body and is provided to light-receiving pixels of a sensor according to an embodiment of the disclosure.

Referring to FIGS. 5A and 5B, an electronic device (e.g., the electronic device 200 in FIGS. 2 and 3) may include the transparent member 310, the display device 330 exposed at least partially through the transparent member 310, the light blocking member 350 disposed to face one surface of the display device 330, and the image sensor 370 which receives at least part of provided light.

The structure of the display device 330 illustrated in FIGS. 5A and 5B may be substantially identical, partially or wholly, to the structures of the display devices 220 and 230 illustrated in FIGS. 2, 3 and 4.

Referring to FIGS. 5A and 5B, regarding a path of light in the biometric sensor module 301, the biometric sensor module 301 may include light emitting devices (3331a in FIG. 4) formed on a display layer (the display element layer 333a in FIG. 4) of the display device 330, the image sensor 370 disposed facing at least a part of the light emitting devices and receiving light reflected from a fingerprint of a user, and the pin-hole structure 360 disposed between the light emitting devices and the image sensor 370.

In accordance with various embodiments of the disclosure, a first path L1 of light from the light emitting devices of the display device 330 may pass through the transparent member 310 and be directed to a fingerprint of the user U touching the active area of the transparent member 310 (see FIG. 5A). The light may be reflected from valleys and/or ridges of the fingerprint of the user U. A second path L2 of the reflected light may pass through the pin-hole structure 360 and reach the image sensor 370 (see FIG. 5B). For example, a fingerprint of the user on the active area A1 of the transparent member 310 may have a convex-concave surface in the form of valleys and/or ridges, and thus may be divided into an area contacting the transparent member 310 and an area which does not contact the transparent member 310. Light may be fully reflected from the area of the fingerprint of the user, which does not contact the transparent member 310, and then travel again, whereas the light may be partially absorbed into the area of the fingerprint, which contacts the transparent member 310, while being scattered and reflected partially. Therefore, light incident on the transparent member 310 which does not contact the fingerprint of the user is fully reflected and travels toward the image sensor 370, whereas light incident on the transparent member 310 contacting the fingerprint of the user is absorbed and refracted or scattered, without traveling to the image sensor 370.

According to an embodiment of the disclosure, the pin-hole structure 360 of the biometric sensor module 301 (e.g., optical fingerprint sensor unit) may be formed in at least a partial area of the light blocking member 350, and may be stacked on the image sensor 370. The image sensor 370 may be disposed near to the display device 330. For example, the image sensor 370 may be disposed in contact with at least part of the rear surface of the display device 330. The resulting decrease of the distance of the light reflected from a user's fingerprint or the like may increase the integrated amount of light on the light-receiving pixels 371 of the image sensor 370, thereby maximizing sensor performance. In another example, when seen from the transparent member 310 of the electronic device, the pin-hole structure 360 may render the image sensor 370 to be invisible by fine patterning, thus offering a sophisticated design.

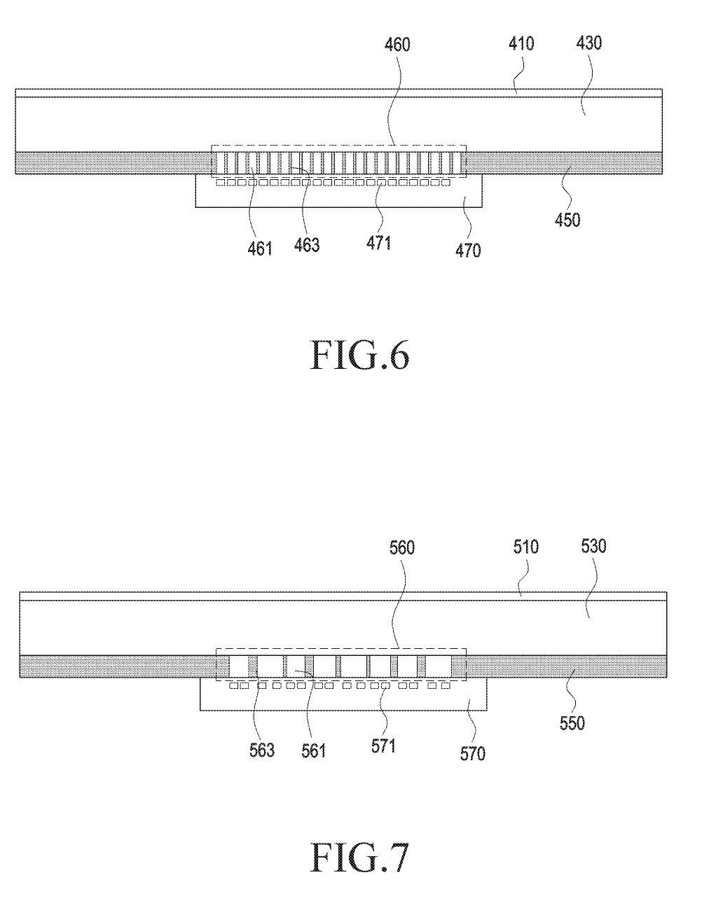

FIG. 6 is a view illustrating arrangement of pin holes in a pin-hole structure (360 in FIGS. 5A and 5B), and arrangement of light-receiving pixels of the image sensor, corresponding to the pin-hole arrangement according to an embodiment of the disclosure.

Referring to FIG. 6, an optical fingerprint sensor may include a display device 430 including light emitting devices, an image sensor 470 including light-receiving pixels 471, and the pin-hole structure 460 disposed between the display device 430 and the image sensor 470, and providing a light path reaching the light-receiving pixels 471.

The display device 430, the image sensor 470, and the pin-hole structure 460 in FIG. 6 may be identical, partially or wholly, to the display device 330, the image sensor 370, and the pin-hole structure 360 in FIGS. 4, 5A and 5B.

According to various embodiments of the disclosure, the display device 430 may include a display element layer (the display element layer 333a in FIG. 4), and the display element layer may include a substrate (not shown), and an encapsulation member (not shown) which covers and thus protects a plurality of pixels formed on the substrate. The substrate may be a transparent substrate such as a substrate formed of glass or a polymer film If the substrate is formed of a polymer film, the substrate may include a flexible substrate. Light emitting devices formed on the display element layer may provide light in the first direction +Z, and the light may be directed to the user's body touching the active area of a transparent member 410 (for example, a fingerprint). The light may be reflected from valleys and/or ridges of the fingerprint of the user, and then reach the image sensor 470 disposed inside the device.

According to various embodiments of the disclosure, the image sensor 470 may be disposed under the display device 430 (e.g., in the second direction −Z), and may receive light passed through the transparent member 410 and the display device 430, and sense fingerprint information about the user. The image sensor 470 may have a plurality of light-receiving pixels 471 arranged therein, for receiving light.

According to various embodiments of the disclosure, the light blocking member 450 may be disposed between the image sensor 470 and the display device 430, in order to suppress light scattering, and the pin-hole structure 460 may be formed in the light blocking member 450. For example, an area of the light blocking member 450, corresponding to the image sensor 470, may be opened, and the pin-hole structure 460 formed in the opening may have a layout corresponding to the light-receiving pixels 471 formed in the image sensor 470. For example, pin holes 461 (e.g., micro-holes) of the pin-hole structure 460 may be arranged apart from each other by a predetermined gap, in a one-to-one correspondence with the plurality of light-receiving pixels 471. Each of the plurality of pin holes 461 may provide a path in which light reflected from a fingerprint of the user is provided to the image sensor 470.

According to an embodiment of the disclosure, a wall 463 may be prepared between every two of the pin holes 461, and guide the reflected light accurately to a light-receiving pixel of the image sensor 470, corresponding to a pin hole. The wall 463 may block noise light which could be provided adjacent to light-receiving pixels. Each wall 463 may be arranged in correspondence with an area between every two of the light-receiving pixels 471 arranged in the underlying image sensor 470, so as to avoid alignment with a light-receiving pixel 471. The wall 463 may be formed in the same thickness and of the same material, as the light blocking member 450. For example, the pin-hole structure 460 may be stacked on the light blocking member 450, which may be realized by micro perforation after the light blocking member 450 is laminated.

FIG. 7 is a view illustrating an array of pin holes in a pin-hole structure, and an array of light-receiving pixels of an image sensor, corresponding to the pin-hole array according to an embodiment of the disclosure.

Referring to FIG. 7, an optical fingerprint sensor may include a display device 530 including light emitting devices, an image sensor 570 including light-receiving pixels, and the pin-hole structure 560 disposed between the display device 530 and the image sensor 570, and providing a light path reaching the light-receiving pixels.

The display device 530, the image sensor 570, and the pin-hole structure 560 in FIG. 7 may be identical, partially or wholly, to the display device 430, the image sensor 470, and the pin-hole structure 460 in FIG. 6. The following description is given, centering on the difference from FIG. 6.

According to various embodiments of the disclosure, the display device 530 may include a display element layer, light emitting devices formed on the display element layer may provide light in the first direction +Z, and the light may be directed to the user's body touching the active area of a transparent member 510 (for example, a fingerprint). The light may be reflected from valleys and/or ridges of the fingerprint of the user, and then reach the image sensor 570 disposed inside the device.

According to various embodiments of the disclosure, the image sensor 570 may be disposed under the display device 530 (e.g., in the second direction −Z), and may receive light passed through the transparent member 510 and the display device 530, and sense fingerprint information about the user. The image sensor 570 may have a plurality of light-receiving pixels 571 arranged therein, for receiving light.

According to various embodiments of the disclosure, the light blocking member 550 may be disposed between the image sensor 570 and the display device 530, in order to suppress light scattering, and the pin-hole structure 560 may be formed in the light blocking member 550. For example, an area of the light blocking member 550, corresponding to the image sensor 570, may be opened, and the pin-hole structure 560 formed in the opening may have a layout corresponding to the light-receiving pixels 571 formed in the image sensor 570. For example, pin holes 561 (e.g., micro-holes) of the pin-hole structure 560 may be arranged apart from each other by a predetermined gap.

According to an embodiment of the disclosure, each of the pin holes 561 may be arranged in correspondence with a plurality of light-receiving pixels 571 of the image sensor 570. For example, the pin holes 561 of the pin-hole structure 560 may be arranged in a 1:n (n>1) correspondence with the light-receiving pixels 571. One pin hole 561 of the pin-hole structure 560 may be formed in a diameter corresponding to the size of a plurality of pixels. Each of the plurality of pin holes 561 may provide a path in which light reflected from a fingerprint of a user is provided to the image sensor 570.

According to an embodiment of the disclosure, a wall 563 may be prepared between every two of the pin holes 561, and guide the reflected light accurately to a plurality of light-receiving pixels 571 of the image sensor 570, corresponding to a pin hole. The wall 563 may block noise light which could be provided adjacent to light-receiving pixels 571. Each wall 563 may be arranged in correspondence with an area between every two of the light-receiving pixels 571 arranged in the underlying image sensor 570, so as to avoid alignment with a light-receiving pixel 571. The wall 563 may have the same thickness and be formed of the same material, as the light blocking member 550. For example, the pin-hole structure 560 may be stacked on the light blocking member 550, which may be realized by micro-perforation after the light blocking member 550 is laminated.

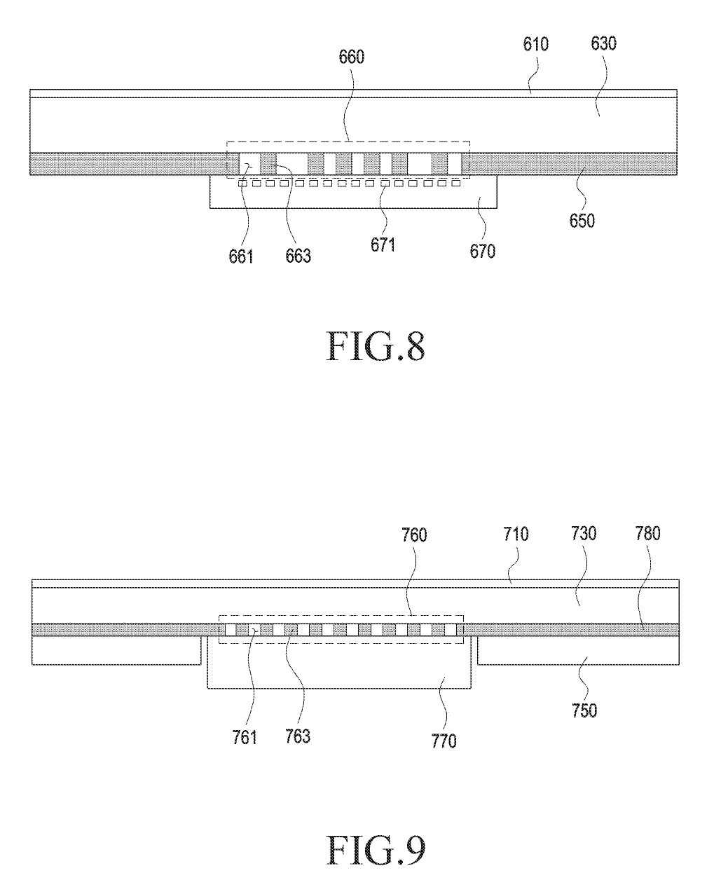

FIG. 8 is a view illustrating arrangement of pin holes in a pin-hole structure, and arrangement of light-receiving pixels of an image sensor, corresponding to the pin-hole arrangement according to an embodiment of the disclosure.

Referring to FIG. 8, an optical fingerprint sensor may include a display device 630 including light emitting devices, an image sensor 670 including light-receiving pixels, and a pin-hole structure 660 disposed between the display device 630 and the image sensor 670, and providing a light path reaching the light-receiving pixels.

The display device 630, the image sensor 670, and the pin-hole structure 660 in FIG. 8 may be identical, partially or wholly, to the display device 430, the image sensor 470, and the pin-hole structure 460 in FIG. 6.

According to various embodiments of the disclosure, the display device 630 may include a display element layer, light emitting devices formed on the display element layer may provide light in the first direction +Z, and the light may be directed to the user's body touching the active area of a transparent member 610 (for example, a fingerprint). The light may be reflected from valleys and/or ridges of the fingerprint of the user, and then reach the image sensor 670 disposed inside the device.

According to various embodiments of the disclosure, the image sensor 670 may be disposed under the display device 630 (e.g., in the second direction −Z), and may receive light passed through the transparent member 610 and the display device 630, and sense fingerprint information about the user. The image sensor 670 may have a plurality of light-receiving pixels 671 arranged therein, for receiving light.

According to various embodiments of the disclosure, a light blocking member 650 may be disposed between the image sensor 670 and the display device 630, in order to suppress light scattering, and the pin-hole structure 660 may be formed in the light blocking member 650. For example, an area of the light blocking member 650, corresponding to the image sensor 670, may be opened, and the pin-hole structure 660 formed in the opening may have a layout corresponding to light-receiving pixels 671 formed in the image sensor 670. For example, pin holes 661 (e.g., micro-holes) of the pin-hole structure 660 may be arranged apart from each other by a predetermined gap. The pin holes 661 of the pin-hole structure 660 may be different in size and arrangement.

According to an embodiment of the disclosure, each of the pin holes 661 may be arranged in correspondence with a plurality of light-receiving pixels 671 of the image sensor 670. For example, the pin holes 561 of the pin-hole structure 660 may be arranged in a 1:n (n≥1) correspondence with the light-receiving pixels 671. One pin hole of the pin-hole structure 660 may be formed in a diameter corresponding to the size of one or more light-receiving pixels 671. Each of the plurality of pin holes 661 may provide a path in which light reflected from a fingerprint of a user is provided to the image sensor 670.

According to an embodiment of the disclosure, a wall 663 may be prepared between every two of the pin holes 661, and guide the reflected light accurately to a plurality of light-receiving pixel 671 of the image sensor 670, corresponding to a pin hole. The wall 663 may block noise light which could be provided adjacent to light-receiving pixels 671. Each wall 663 may be arranged in alignment with at least one light-receiving pixel 671 arranged in the underlying image sensor 670. The wall 663 aligned with the light-receiving pixel 671 may limit reception of reflected light directed to some pixels. The limited area may be compensated by interpolation between images, when the image sensor 670 captures the images. For example, an image signal processor (not shown) in the electronic device may perform an image process (e.g., depth map generation, three-dimensional modeling, panorama generation, feature point extraction, image synthesis, or image compensation (e.g., noise reduction, resolution adjustment, brightness adjustment, blurring, sharpening, or softening)) on an image acquired through the image sensor or stored in a memory.

According to an embodiment of the disclosure, the wall 663 may have the same thickness and be formed of the same material, as the light blocking member 650. For example, the pin-hole structure 660 may be stacked on the light blocking member 650, which may be realized by micro-perforation after the light blocking member 650 is laminated.

FIG. 9 is a view illustrating a relationship between arrangement of a pin-hole structure, and arrangement of an image sensor, corresponding to the arrangement of the pin-hole structure according to an embodiment of the disclosure.

Referring to FIG. 9, an optical fingerprint sensor may include a display device 730 including light emitting devices, an image sensor 770 including light-receiving pixels, and a pin-hole structure 760 disposed between the display device 730 and the image sensor 770, and providing a light path reaching the light-receiving pixels.

The display device 730, the image sensor 770, and the pin-hole structure 760 in FIG. 9 may be identical, partially or wholly, to the display device 330, the image sensor 370, and the pin-hole structure 360 in FIGS. 4, 5A and 5B.

According to various embodiments of the disclosure, the display device 730 may include a display element layer, light emitting devices formed on the display element layer may provide light in the first direction +Z, and the light may be directed to the user's body touching the active area of a transparent member 710 (for example, a fingerprint). The light may be reflected from valleys and/or ridges of the fingerprint of the user, and then reach the image sensor 770 disposed inside the device.

According to various embodiments of the disclosure, a light blocking member 750 may be disposed under the display device 730, in order to suppress light scattering, and the image sensor 770 may be disposed at least partially on the same layer as the light blocking member 750. The light blocking member 750 may suppress light scattering to the outside (e.g., in the rear direction of the electronic device in FIG. 3) by controlling light to be directed to a transparent member 710. In another example, an area of the light blocking member 750 may be opened in order to provide light received from the transparent member 710 to the image sensor 770. For example, an area of the light blocking member 750, corresponding to the image sensor 770 may be opened, and the image sensor 770 may be disposed at least partially in the opening. As the image sensor 770 is disposed near to at least part of the display device 730, the resulting reduction of the distance of light reflected from a user's fingerprint or the like leads to an increase in the integrated amount of light provided to the light-receiving pixels of the image sensor 770, thereby maximizing sensor performance.

According to various embodiments of the disclosure, a film layer 780 may be disposed between the image sensor 770 and the display device 730, and the pin-hole structure 760 may be formed on the film layer 780. For example, an area of the film layer 780, corresponding to the image sensor 770, may be opened, and the pin-hole structure 760 may be formed in the opening, thereby providing space in which light provided through an area of the transparent member 710 reaches the image sensor 770.

According to an embodiment of the disclosure, the film layer 780 may be disposed between the display device 730 and the light blocking member 750, in contact with the display device 730 and the light blocking member 750. For example, the film layer 780 may contain, for example, silicon, air, foam, membrane, OCA, sponge, rubber, ink, or polymer (PC or PET).

According to an embodiment of the disclosure, the pin-hole structure 760 formed on the film layer 780 may have a plurality of pin holes 761 (e.g., micro-holes) formed in an area facing the image sensor 770, and the plurality of pin holes 761 may provide a path in which light reflected from a fingerprint of a user is provided to the image sensor 770.

According to an embodiment of the disclosure, the pin-hole structure 760 may have a layout corresponding to the light-receiving pixels of the image sensor 770. For example, the pin holes 761 of the pin-hole structure 760 may be arranged apart from each other by a predetermined gap, each in correspondence with one or more light-receiving pixels of the image sensor 770. A wall 763 may be prepared between every two of the pin holes 761, and guide the reflected light accurately to at least one pixel of the image sensor 770, corresponding to a pin hole. The wall 763 may have the same thickness and be formed of the same material, as the light blocking member 750. For example, the pin-hole structure 760 may be stacked on the light blocking member 750, which may be realized by micro-perforation after the light blocking member 750 is laminated.

According to various embodiments of the disclosure, an electronic device may include a transparent member (310 in FIG. 4), a display panel (433 in FIG. 4) disposed under the transparent member, and including a plurality of pixels (3331a in FIG. 4), a biometric sensor (the biometric sensor module 301 in FIG. 4) disposed under the display panel, and configured to acquire at least part of light reflected from an external object contacting at least a partial area of the transparent member in light emitted from at least a part of the plurality of pixels (3331a in FIG. 4), and a light blocking member (350 in FIG. 4) disposed between the display panel and the biometric sensor, and including a plurality of micro-holes formed in at least a partial area of the light blocking member. The at least partial area having the micro-holes formed therein may face the biometric sensor, to enable the reflected light to be transmitted therethrough.

According to various embodiments of the disclosure, an electronic device (200 in FIG. 2) may include a housing (210 in FIG. 2) including a first surface facing in a first direction, a second surface facing in a second direction opposite to the first direction, and a transparent member (310 in FIG. 4) forming at least part of the first surface, a display device (330 in FIG. 4) disposed between the first surface and the second surface of the housing, and configured to display information to the outside through the transparent member, a light blocking member (350 in FIG. 4) disposed to face one surface of the display device, and configured to block light directed in the second direction from the display device, and a biometric sensor module (301 in FIG. 4) disposed between the first surface and the second surface of the housing, and configured to sense a fingerprint of a user touching the transparent member. The biometric sensor module may include a plurality of light emitting devices (3331a in FIG. 4) configured to emit light toward the transparent member, an image sensor (370 in FIG. 4) disposed to face one surface of the light blocking member, and configured to sense light reflected from an external object, and a pin-hole structure (360 in FIG. 4) formed inside or near to the light blocking member, and configured to provide a path for the reflected light directed toward the image sensor.

According to various embodiments of the disclosure, the biometric sensor module may sense the fingerprint of the user by using light emitted from the display device.

According to various embodiments of the disclosure, the pin-hole structure may include a plurality of pin holes (361 in FIG. 4) arranged apart from each other by a predetermined gap in an area facing the image sensor, and a plurality of walls (363 in FIG. 4), each disposed between pin holes, and configured to block interference of the reflected light.

According to various embodiments of the disclosure, the image sensor may include a plurality of light-receiving pixels arranged apart from each other by a predetermined gap, and the arrangement of the plurality of pin holes in the pin-hole structure may correspond to arrangement of the plurality of light-receiving pixels.

In accordance with various embodiments of the disclosure, when seen from above the transparent member, a whole area of the image sensor may substantially overlap with the display device.

According to various embodiments of the disclosure, light emitted from the plurality of light-receiving devices may form a first path (L1 in FIG. 5A) passing through the transparent member and directed in the first direction, and the plurality of pin holes in the pin-hole structure may form a second path (L2 in FIG. 5B) guiding light reflected from the fingerprint of the user to pass through the transparent member and travel toward the image sensor.

According to various embodiments of the disclosure, the image sensor may be configured to sense biometric information about the user touching the transparent member by receiving the light traveling in the second path.

According to various embodiments of the disclosure, the plurality of walls in the pin-hole structure may be formed in the same thickness as and of the same material as the light blocking member.

According to various embodiments of the disclosure, the display device may include an OLED.

According to various embodiments of the disclosure, the electronic device may further include a processor configured to acquire biometric information about the user by using the at least one image sensor or a communication module of the electronic device, determine at least one service related to the biometric information from among a plurality of services supported by the electronic device, and provide the determined at least one service.

According to various embodiments of the disclosure, the pin-hole structure may include a plurality of pin holes arranged apart from each other by a predetermined gap in an area facing the image sensor, and a plurality of walls, each being disposed between pin holes and configured to block interference of the reflected light, the image sensor may include a plurality of light-receiving pixels arranged apart from each other by a predetermined gap, and the center of each of the plurality of pin holes may be aligned with the center of each of the plurality of light-receiving pixels.

According to various embodiments of the disclosure, the pin-hole structure may include a plurality of pin holes arranged apart from each other by a predetermined gap in an area facing the image sensor, and a plurality of walls, each being disposed between pin holes and configured to block interference of the reflected light, the image sensor may include a plurality of light-receiving pixels arranged apart from each other by a predetermined gap, and the plurality of pin holes may be arranged in a 1:n (n is an integer satisfying n>1) correspondence with the plurality of light-receiving pixels.

According to various embodiments of the disclosure, the electronic device may further include a film layer (780 in FIG. 9) disposed between the display device (730 in FIG. 9) and the light blocking member (750 in FIG. 9), the pin-hole structure (760 in FIG. 9) may be formed on the same layer as the film layer, and include a plurality of pin holes (761 in FIG. 9) arranged apart from each other by a predetermined gap in an area facing the image sensor (770 in FIG. 9), and a plurality of walls (763 in FIG. 9), each being disposed between pin holes and configured to block interference of the reflected light.

According to various embodiments of the disclosure, the light blocking member may include an opening in an area corresponding to the pin-hole structure, and the image sensor may be disposed in at least part of the opening.

According to various embodiments of the disclosure, a biometric sensor module may include a plurality of light emitting devices configured to emit light toward the outside, an image sensor disposed to face at least part of arrangement of the plurality of light emitting devices, and configured to sense the emitted light after the emitted light is reflected from a user's body, and a pin-hole structure disposed between the plurality of light emitting devices and the image sensor, and configured to guide a path of the reflected light directed toward the image sensor. The pin-hole structure may include a plurality of pin holes arranged apart from each other by a predetermined gap in an area facing the image sensor, and a plurality of walls, each disposed between pin holes, and configured to block interference of the reflected light.

According to various embodiments of the disclosure, the biometric sensor module may be disposed inside an electronic device including a display device, and the light emitting devices of the biometric sensor module may be at least a part of light emitting devices of the display device.

According to various embodiments of the disclosure, the image sensor may include a plurality of light-receiving pixels arranged apart from each other by a predetermined gap, and the arrangement of the plurality of pin holes in the pin-hole structure may correspond to arrangement of the plurality of light-receiving pixels.

According to various embodiments of the disclosure, the plurality of pin holes may be disposed to face at least one light-receiving pixel.

According to various embodiments of the disclosure, a light blocking member may be disposed under the display device, for blocking light directed in a direction, and the plurality of walls in the pin-hole structure may be formed in the same thickness as and of the same material as the light blocking member.

According to various embodiments of the disclosure, a portable electronic device may include a display device having a plurality of light emitting devices disposed therein, a transparent member including an active area which provides information to be displayed to the outside through the display device, and an inactive area extended from the active area to a periphery of the transparent member, a sensor disposed to face at least part of the active area and configured to sense light which has been emitted from the light emitting devices and reflected from a user's body, and a pin hole structure disposed between the transparent member and the sensor, and configured to guide a path of the reflected light directed toward the sensor.

As is apparent from the foregoing description, according to various embodiments of the disclosure, an electronic device may overcome the limit of the installation space of the electronic device by a display device, and a biometric sensor module (e.g., an optical fingerprint sensor) disposed in an active area of a transparent member.

According to various embodiments of the disclosure, an electronic device may save installation space and cost, and secure sensing performance by using a light emitting device disposed inside a display device as a light emitting device, and an image sensor as a light receiving device in sensing fingerprint information about a user by a biometric sensor module (e.g., an optical fingerprint sensor).

According to various embodiments of the disclosure, since a pin-hole structure (e.g., micro-holes) is disposed inside an electronic device, a biometric sensor module (e.g., an optical fingerprint sensor) in the electronic device may improve outward visibility, and secure sensing performance by reducing a sensing distance from which a user's fingerprint is sensed.

While the disclosure has been shown and described with reference to certain various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a transparent member;
a display panel disposed under the transparent member and comprising a plurality of pixels;
a biometric sensor disposed under the display panel, and configured to acquire at least part of light reflected from an external object contacting at least a partial area of the transparent member in light emitted from at least a part of the plurality of pixels; and
a light blocking member disposed between the display panel and the biometric sensor, and comprising a plurality of micro-holes formed in at least a partial area of the light blocking member,
wherein the at least partial area having the micro-holes formed therein faces the biometric sensor, to enable the reflected light to be transmitted therethrough.

2. An electronic device comprising:
a housing comprising:
a first surface facing in a first direction, a second surface facing in a second direction opposite to the first direction, and
a transparent member forming at least part of the first surface;
a display device disposed between the first surface and the second surface of the housing, and configured to display information to the outside through the transparent member;
a light blocking member disposed to face one surface of the display device, and configured to block light directed in the second direction from the display device; and
a biometric sensor module disposed between the first surface and the second surface of the housing, and configured to sense a fingerprint of a user touching the transparent member,
wherein the biometric sensor module comprises:
a plurality of light emitting devices configured to emit light toward the transparent member;
an image sensor disposed to face one surface of the light blocking member, and configured to sense light reflected from an external object; and
a pin-hole structure formed inside or near to the light blocking member, and configured to provide a path for the reflected light directed toward the image sensor.

3. The electronic device of claim 2, wherein the biometric sensor module senses the fingerprint of the user by using light emitted from the display device.

4. The electronic device of claim 3, wherein the pin-hole structure comprises:
a plurality of pin holes arranged apart from each other by a predetermined gap in an area facing the image sensor; and
a plurality of walls, each disposed between pin holes, and configured to block interference of the reflected light.

5. The electronic device of claim 4,
wherein the image sensor comprises a plurality of light-receiving pixels arranged apart from each other by a predetermined gap, and
wherein an arrangement of the plurality of pin holes in the pin-hole structure corresponds to arrangement of the plurality of light-receiving pixels.

6. The electronic device of claim 2, wherein when seen from above the transparent member, a whole area of the image sensor substantially overlaps with the display device.

7. The electronic device of claim 4, wherein light emitted from the plurality of light-emitting devices forms a first path passing through the transparent member and directed in the first direction, and the plurality of pin holes in the pin-hole structure form a second path guiding light reflected from the fingerprint of the user to pass through the transparent member and travel toward the image sensor.

8. The electronic device of claim 7, wherein the image sensor is configured to sense biometric information about the user touching the transparent member by receiving the light traveling in the second path.

9. The electronic device of claim 5, wherein the plurality of walls in the pin-hole structure are formed in the same thickness as and of the same material as the light blocking member.

10. The electronic device of claim 5, wherein the display device comprises an organic light emitting diode (OLED).

11. The electronic device of claim 5, further comprising:
a processor configured to:
acquire biometric information about the user by using at least one of the image sensor or a communication module of the electronic device,
determine at least one service related to the biometric information from among a plurality of services supported by the electronic device, and
provide the determined at least one service.

12. The electronic device of claim 2,
wherein the pin-hole structure comprises a plurality of pin holes arranged apart from each other by a predetermined gap in an area facing the image sensor, and a plurality of walls, each being disposed between pin holes and configured to block interference of the reflected light,
wherein the image sensor comprises a plurality of light-receiving pixels arranged apart from each other by a predetermined gap, and
wherein a center of each of the plurality of pin holes is aligned with a center of each of the plurality of light-receiving pixels.

13. The electronic device of claim 2,
wherein the pin-hole structure comprises a plurality of pin holes arranged apart from each other by a predetermined gap in an area facing the image sensor, and a plurality of walls, each being disposed between pin holes and configured to block interference of the reflected light,
wherein the image sensor comprises a plurality of light-receiving pixels arranged apart from each other by a predetermined gap, and
wherein the plurality of pin holes are arranged in a 1:n (n is an integer satisfying n>1) correspondence with the plurality of light-receiving pixels.

14. The electronic device of claim 3, further comprising:
a film layer disposed between the display device and the light blocking member,
wherein the pin-hole structure is formed on the same layer as the film layer and comprises:
a plurality of pin holes arranged apart from each other by a predetermined gap in an area facing the image sensor; and
a plurality of walls, each being disposed between pin holes and configured to block interference of the reflected light.

15. The electronic device of claim 14, wherein the light blocking member comprises an opening in an area corresponding to the pin-hole structure, and the image sensor is disposed in at least part of the opening.

16. A biometric sensor module comprising:
a plurality of light emitting devices configured to emit light toward the outside;
an image sensor disposed to face at least part of arrangement of the plurality of light emitting devices, and configured to sense the emitted light after the emitted light is reflected from a user's body; and
a pin-hole structure disposed between the plurality of light emitting devices and the image sensor, and configured to guide a path of the reflected light directed toward the image sensor,
wherein the pin-hole structure comprises:
a plurality of pin holes arranged apart from each other by a predetermined gap in an area facing the image sensor, and
a plurality of walls, each disposed between pin holes, and configured to block interference of the reflected light.

17. The biometric sensor module of claim 16,
wherein the biometric sensor module is disposed inside an electronic device comprising a display device, and
wherein the light emitting devices of the biometric sensor module are at least a part of light emitting devices of the display device.

18. The biometric sensor module of claim 17,
wherein the image sensor comprises a plurality of light-receiving pixels arranged apart from each other by a predetermined gap, and
wherein the arrangement of the plurality of pin holes in the pin-hole structure corresponds to arrangement of the plurality of light-receiving pixels.

19. The biometric sensor module of claim 17, wherein the plurality of pin holes are disposed to face at least one light-receiving pixel.

20. The biometric sensor module of claim 17,
wherein a light blocking member is disposed under the display device, for blocking light directed in a direction, and
wherein the plurality of walls in the pin-hole structure are formed in the same thickness as and of the same material as the light blocking member.
